(19) United States
(12) Patent Application Publication
(10) Pub. No.: US 2011/0100551 A1
(43) Pub. Date: May 5, 2011

(54) Adhesive assembly tape for interior finishing

(75) Inventors: Bernhard Müssig, Seevetal (DE); Kerstin Metzler, Hamburg (DE); Stephan Bünz, Ostrohe (DE); Christian Kreft, Hamburg (DE)

(73) Assignee: TESA SE, Hamburg (DE)

(21) Appl. No.: 12/904,511

(22) Filed: Oct. 14, 2010

(30) Foreign Application Priority Data
Nov. 3, 2009 (DE) 10 2009 046 363.1

(51) Int. Cl. C09J 7/02; C09J 119/00; B32B 37/12; C09J 7/04

(52) U.S. Cl. 156/334; 428/355 EN; 428/341; 442/58

(57) ABSTRACT

Adhesive assembly tape for interior finishing, comprising a carrier and an adhesive coated from the melt to at least one side of said carrier,

characterized in that
the adhesive comprises an ethylene-propylene rubber having a density of between 0.86 and 0.89 g/cm³ and a tackifier resin.

The invention relates to an adhesive assembly tape for the interior finishing of roofs in buildings, especially for the adhesive bonding of wind seals, vapour diffusion retarders and vapour barriers.

After heat insulation materials have been attached to walls, roof areas and the like, it is usual to install films or film composites in order to prevent loss of energy through draughts and condensation of moisture from the building in the insulating material and timbers. For attachment to a wide variety of substrates and also for the tight sealing of the resultant overlaps and outer edges, single-sidedly or double-sidedly bonding assembly tapes are used.

All of the adhesive assembly tapes used in the roof area are subjected to exacting requirements in relation to their water resistance, adhesiveness, not least at temperatures down to 0° C., ageing stability, and sealing capacity. The bond made to dirty and/or rough substrates, such as concrete surfaces or wooden rafters, for example, must hold securely. Given that the wind seals, vapour diffusion retarders and vapour barriers are commonly composed of polyolefin films, strong adhesion to non-polar substrates of that kind is also required.

A single-sidedly bonding assembly tape for the adhesive bonding of wind seals, vapour diffusion retarders and vapour barriers is described in DE 297 23 454 U1. Like the products typically obtainable on the market, this assembly tape is composed of a film and an acrylate adhesive.

In practice, assembly tapes with coatweights of approximately 200 g/m² are offered, to allow effective bonding to rough substrates. Coatweights of more than 80 g/m², as the result of the drying of an adhesive solution or dispersion, are very laborious and hence expensive. Acrylate adhesives feature high adhesion to polar substrates, but particularly poor adhesion to non-polar substrates such as polyolefins. Polyethylene films, as are typically used in roof finishing, are therefore bonded only with difficulty. Rubber adhesives would be of advantage in this respect, but their ageing stability is too low. The assembly tapes common on the market are based on acrylate dispersions; in the wet, they very largely lose their adhesive power, as a result of re-emulsification.

It is an object of the invention to provide a remedy to this situation and to make available an ageing-stable and well-adhering assembly tape for interior finishing, especially for the roof area.

This object is achieved by means of an assembly tape as specified in the main claim. Advantageous developments of the subject matter of the invention, and also uses, are given in the dependent claims.

Ethylene-propylene rubbers (known as EPM and EPDM) are considered by the skilled person not to be suitable for high-grade pressure-sensitive adhesives. They can be used for tacky layers of removable surface protection films with a bond strength of significantly below 1 N/cm. They are also contemplated as a vulcanizable component in adhesives for roofing sheets.

Nevertheless, ethylene-propylene rubber with a density of between 0.86 and 0.89 g/cm³ can be used with a tackifier resin, surprisingly, to produce highly suitable assembly tapes for interior finishing in the roof area, and feature high adhesion to polyethylene films and unsanded roof beams, brick or plaster.

The invention accordingly provides an assembly tape for interior finishing, comprising a carrier and an adhesive coated onto at least one side of said carrier, said adhesive comprising an ethylene-propylene rubber having a density of between 0.86 and 0.89 g/cm³, preferably between 0.86 and 0.88 g/cm³, and a tackifier resin.

As well as ethylene and propylene, the ethylene-propylene rubber may also include further monomers such as butene, octene or a diene. The Mooney viscosity ML 1+4 at 125° C. is preferably at least 20, more preferably 40 and more particularly at least 60. The higher the Mooney viscosity, the better the behaviour of the assembly tape in a heat and humidity storage test.

Given the limited selection of suitable diene-free ethylene-propylene rubbers (EPM), EPDM rubbers (i.e. ethylene-propylene rubbers with a diene) are preferred. Also advantageous is their crosslinkability by high-energy radiation or chemicals such as peroxides, phenolic resins or sulphur compounds. As well as ethylene and propylene, EPDM rubbers include a diene, usually ethylidene-norbornene (ENB) but also dicyclopentadiene or 5-vinyl-2-norbornene.

For the adhesive to be sufficiently tacky and not to need any plasticizer, or to need only a little, the crystallinity ought to be as low as possible; this is best achieved with an ethylene content of less than 75%, preferably less than 60%, by weight. Serving as a measure of the crystallinity are crystallite melting point and heat of fusion. The crystallite melting point is preferably below 105° C., more preferably below 80° C. and more particularly below 50° C. The heat of fusion is preferably below 40 J/g, more preferably below 20 J/g, and more particularly is so small that it cannot be determined by DSC.

Since the addition of other polyolefins with considerable crystallinity, such as partially crystalline ethylene, propylene or butene polymers, is likewise poor for the tack, polyolefins having a crystallite melting point of 105° C. or higher, or even those having a crystallite melting point of 90° C. or higher, are preferably not to be included in the adhesive. The ethylene-propylene rubber preferably has a melt index of less than 0.5 g/10 min, more preferably of less than 0.2 g/10 min.

The ethylene-propylene rubber is preferably grafted with a crosslinkable comonomer such as vinylsilane (for example vinyltriethoxysilane), glycidyl methacrylate, acrylic acid, hydroxyethyl methacrylate and, more preferably, maleic anhydride. With particular advantage the adhesive of the invention can be crosslinked, for example, with isocyanates, epoxides, titanium compounds, aluminium compounds, zinc compounds, oxazolines, aziridines or amines.

Highly suitable tackifier resins are resins based on rosin, hydrocarbons such as piperylene or terpenes such as β-pinene, preferably in partially or completed hydrogenated form. The amount is preferably 130 to 350 phr (phr denotes parts by weight per 100 parts by weight of rubber).

The adhesive preferably comprises a liquid plasticizer such as, for example, mineral oils, liquid polymers comprising isobutene homopolymer and/or isobutene-butene copolymer, liquid resins and plasticizer resins having a melting point of below 40° C. and based on the raw materials of tackifier resins.

The adhesive of the invention will work without antioxidant. For a high long-term stability it is preferred to use a primary antioxidant, on a phenolic basis, for example, particularly preferably at not less than 2 phr, and optionally a secondary antioxidant as well. For applications in which the adhesive tape is subject to the light (for example, to insolation) for a relatively long time, it is preferred to use a light stabilizer, more preferably a HALS such as Tinuvin 111 or Tinuvin 922, a UV absorber such as Tinuvin P, or opaque pigment.

For optimization of the properties, the self-adhesive composition employed may be blended with further additives such as fillers, flame retardants, pigments, antiozonants, photoinitiators, or crosslinking agents or crosslinking promoters. Examples of suitable fillers and pigments include carbon black, titanium dioxide, calcium carbonate, zinc carbonate, zinc oxide, silicates or silica.

In accordance with one advantageous embodiment, the sum of the proportions of the additives or other adjuvants does not exceed 5% by weight.

The pressure-sensitive adhesives may be prepared and processed from solution and also from the melt. The advantage of processing the pressure-sensitive adhesive from the melt lies in the possibility of being able to achieve very high coat thicknesses (coatweights) in a very short time, since there is no need to remove solvent after the coating operation. Preferred preparation and processing methods therefore take place from the melt. For the latter case, suitable preparation operations include not only batch methods but also continuous methods. Particularly preferred is the continuous production of the pressure-sensitive adhesive with the aid of an extruder and its subsequent coating directly onto the target substrate or a release paper or release film, with the adhesive at an appropriately high temperature. Coating methods preferred are extrusion coating with slot dies, and calender coating.

The coatweight (coating thickness) depending on application, is preferably between 50 and 300 g/m², more preferably between 100 and 150 g/m², and on account of the high adhesion power may be lower than for commercially customary acrylate-based assembly tapes.

Since the adhesive can be prepared solventlessly, even high coatweights can be readily accomplished by means of melt coating.

The adhesive is preferably crosslinked.

The bond strength to steel is preferably at least 10 N/cm.

Carrier material used may comprise polymeric films, such as films of polyethylene, polypropylene, polybutene, their copolymers, blends of these polymers, for example, with polyethylene-vinyl acetate or ionomers, and also films of polyvinyl chloride, for example. Stretchable films may be strengthened by a reinforcement, preferably a nonwoven scrim. Also possible is the use of paper/plastic composites, which are obtained, for example, by extrusion coating or lamination. Depending on application, textile materials may be used in open-pored form or in the form of a textile/plastic composite as carrier material.

The carrier preferably comprises at least one ply, preferably a film such as of polyolefin, polyester, PVC or paper or a nonwoven scrim or a textile, or of an assembly of these materials.

The carrier material may, for example, have thicknesses of between 30 and 150 μm, preferably between 50 and 120 μm.

On the coating side, the surfaces of the carriers may have been chemically or physically (for example by corona) pretreated in order to improve adhesive anchorage, and their reverse may have been given an anti-adhesive physical treatment or a coating such as, for example, of silicone or polyvinyl stearyl carbamate.

The assembly tape is formed by application to the carrier, partially or over the whole area, preferably on one or, if desired, both sides, of the adhesive. Furthermore, coating may also take place to both sides of the carrier material, to give a double-sided adhesive tape. The assembly tape may be lined with one or two liners (release films or release papers). In one preferred embodiment, films or papers treated with silicone or polyvinyl stearyl carbamate, such as, for example, glassine, HDPE or LDPE coated papers, are used as liners.

The assembly tape of the invention is suitable for use in interior finishing, especially in the roof area of buildings. Preference is given to its use for the adhesive bonding of wind seals, vapour diffusion retarders or vapour barriers, especially those of films or film-comprising composites, more preferably of those comprising polyolefins such as polyethylene.

### Test methods

The measurements, unless indicated otherwise, are carried out under test conditions of 23±1° C. and 50±5% relative humidity.

The density of the rubber is determined in accordance with ISO 1183 and expressed in g/cm³. The crystallite melting point is determined by DSC in accordance with ISO 3146 with a heating rate of 10° C./min. The melt index is tested in accordance ISO 1133 at 190° C. and 2.16 kg and expressed in g/10 min. The Mooney viscosity is measured in accordance with ASTM D 1646 under the ML 1+4 testing conditions at 125° C.

The thickness is determined in accordance with DIN 53370, with the gauge being planar (not curved). In the case of structured films, however, the thickness taken is that prior to embossing. It can also be determined subsequently via the basis weight (determined in accordance with DIN 53352) with conversion using the density. The depth of embossing is the difference between the thicknesses with and without embossing.

The bond strengths to steel are determined at a peel angle of 180° in a method based on AFERA 4001 on test strips which have a width (as far as possible) of 20 mm. In this test, the test substrates used are steel plates conforming to the AFERA standard, to which a strip of the test assembly tape is applied. Where double-sided adhesive tapes are tested, the side not for testing is lined with a strip of unplasticized PVC having a width of 20 mm and a thickness of 30 μm. Testing takes place in accordance with AFERA 4001.

Bond strengths to polyethylene are determined on adhesive bonds, 20 mm wide, of a 190 μm thick polyethylene film to the assembly tape, without storage beforehand. The film is attached perpendicularly at the bottom, and the adhesive tape is peeled perpendicularly upwards at a rate of 300 mm/min. For adhesive tapes with soft carrier films or double-sided adhesive tapes, the procedure is the same as for the determination of the bond strength to steel.

The coatweight is determined by removing the adhesive with a solvent and subsequently drying the carrier.

The shear strength is tested in principle as described in EP 1 582 575 B1, paragraph [0066] (the tests carried out here take place at 23° C. on steel with a test weight of 1 kg). The shear strength is referred to there as the shear withstand time.

For determination of the ageing stability, adhesive bonds of the adhesive tape on commercially customary wind seals, vapour diffusion retarders or vapour barriers are tested in analogy to “Pressure-sensitive adhesive tapes, testing and labelling specifications for interior applications” of the German Airtightness in Construction group (FLiB), 13.04.2005 version, diagram 7-1. The strip is 20 mm wide, with 100 mm adhered to a 190 μm LDPE film with a surface tension of 34 mN/m, and the end hanging down perpendicularly is likewise 100 mm long. The test conditions are 65° C. and 80% relative humidity (heat and humidity storage test). After 11 days, measurement takes place to determine the number of mm by which the test strip has undergone detachment due solely to its inherent weight.

The invention is illustrated below by a number of examples, without any intention that the invention should be confined thereto.

Raw materials of the examples:

| | |
|---|---|
| Vistalon 7500: | EPDM, Mooney viscosity 91, ethylene content 55.5% by weight, |
| | ENB content 5.7% by weight, crystallite melting point not |
| | measurable, heat of fusion not measurable, melt index <0.1 g/ |
| | 10 min |
| Keltan DE 5005: | ethylene-propylene rubber based on Keltan 3200 grafted with 2% |
| | maleic anhydride, ethylene content 49%, Mooney after grafting 65, |
| | crystallite melting point not measurable, heat of fusion not |
| | measurable |
| Buna EP XT 2708 VP: | ethylene-propylene rubber, 68% ethylene, ENB 0%, 0.8% maleic |
| | anhydride grafted on, Mooney 28, melt index 0.10 g/10 min |
| Buna EP G 2170 VP: | EPDM, ethylene content 72%, Mooney 25, ENB 1.2%, density |
| | 0.86 g/cm³, melt index 0.0 g/10 min at 190° and 0.1 g/10 min at |
| | 230° C. |
| Vistamaxx 3000: | copolymer of propylene and ethylene, melt index 7 g/10 min, |
| | density 0.871 g/cm³, flexural modulus 40 MPa, crystallite melting |
| | point 56° C., Mooney viscosity 4 |
| Ondina 933: | white oil (paraffinic-naphthenic mineral oil) |
| Wingtack 10: | liquid C₅ hydrocarbon resin |
| Wingtack 95: | non-hydrogenated C₅ hydrocarbon resin with a melting point of |
| | 95° C. |
| Escorez 1310: | non-hydrogenated C₅ hydrocarbon resin, melting point 94° C., |
| | polydispersity 1.5 |
| Wingtack extra: | aromatics-modified C₅ hydrocarbon resin, melting point 97° C., |
| | polydispersity 1.6 |
| Regalite R1100: | hydrogenated aromatic hydrocarbon resin, melting point 100° C., |
| | polydispersity 1.9 |
| Foral 85: | fully hydrogenated glyceryl ester of rosin, with a melting point of |
| | 85° C. and a polydispersity of 1.2 |
| Irganox 1726: | phenolic antioxidant with sulphur-based function of a secondary |
| | antioxidant |
| Irganox 1076: | phenolic antioxidant |
| Tinuvin 111: | HALS-type light stabilizer |
| Polypox H 205: | α,ω-diamino-polypropylene oxide (crosslinker) |

### EXAMPLE 1

The adhesive is made up of the following components:

| | |
|---|---|
| 100 phr | Vistalon 7500, |
| 78 phr | Ondina 933, |
| 212 phr | Regalite 1100, |
| 2 phr | Irganox 1726. |

The adhesive is prepared continuously in an extruder and applied at 150 g/m² from the melt to the carrier by means of nozzle coating. The carrier is a kraft paper with a grammage of 100 g/m² and a reverse-face melt coating of 20 g/m² polyethylene, and with a release coating of silicone.

Bond strength to steel is 23.5 N/cm and to polyethylene 22 N/cm. The adhesive tape can be adhered even at 10° C. to masonry and wooden beams. Detachment in the heat and humidity storage test: 2 mm.

### EXAMPLE 2

Adhesive as in Example 1, but with the following formula:

| | |
|---|---|
| 100 phr | Vistalon 7500, |
| 78 phr | Ondina 933, |
| 212 phr | Escorez 1310, |
| 2 phr | Irganox 1076. |

The adhesive is prepared continuously in an extruder and is applied at 50 g/m² from the melt to a release paper by means of nozzle coating. The carrier film possesses a thickness of 70 μm and is composed of 91.3% (w/w) of Novolen 2309 L block copolymer (BASF, melt index 6 g/10 min at 230° C. and 2.16 kg, ethylene content about 6.5% (w/w)), 8.4% (w/w) of titanium dioxide and 0.3% (w/w) of the HALS stabilizer Tinuvin 770. It is corona-treated on one side prior to coating. Application of the adhesive takes place to the corona-treated side of the carrier material by lamination from coated release paper. The adhesive tape is wound to form log rolls, without removal of the release paper.

The bond strength to steel is 16.2 N/cm. The bond strength to polyethylene is 13.7 N/cm. The shear strength at 23° C. is 30 minutes. After ageing, the bond strength to polyethylene is still 90% of the original bond strength. The adhesive tape can be adhered even at 0° C. to masonry, unsanded wood, polyethylene film or polyamide film.

### EXAMPLE 3

Adhesive as in Example 2, but with the following formula:

| | |
|---|---|
| 100 phr | Vistalon 7500, |
| 78.4 phr | Wingtack 10, |
| 212 phr | Wingtack 95, |
| 2 phr | Irganox 1076 |
| 5 phr | Tinuvin 111. |

The adhesive is also coated as in Example 2. The adhesive tape is produced in the same way, but both sides of the carrier are corona-treated and coated with the adhesive. After the second transfer coating, the second release paper is removed and the adhesive tape is wound to form log rolls.

The bond strength to steel is 15 N/cm. The bond strength to polyethylene is 7 N/cm. After ageing, the bond strength to polyethylene is still 92% of the original bond strength. The shear strength at 23° C. is 50 minutes. The adhesive tape can be adhered even at 0° C. to masonry, unsanded wood, polyethylene film or polyamide film.

### EXAMPLE 4

Adhesive as in Example 1, but with the following formula:

| | |
|---|---|
| 100 phr | Buna EP G 2170 VP, |
| 64 phr | Ondina 933, |
| 193 phr | Regalite R1100 |
| 2 phr | Polypox H 205 |
| 2 phr | Irganox 1076. |

The adhesive is coated as in Example 2, but with a coatweight of 200 g/m², and is wound to form log rolls without removal of the release paper. It is employed as a carrierless, double-sidedly adhesive transfer tape for the fastening, for example, of wind seals, vapour diffusion retarders and vapour barriers to unsanded wood.

The bond strength to polyethylene is 5 N/cm. After ageing, the bond strength to polyethylene is still 96% of the original bond strength. The shear strength at 23° C. is 850 minutes. Detachment in the heat and humidity storage test: <1 mm. The adhesive tape can be adhered even at 0° C. to masonry, unsanded wood, polyethylene film or polyamide film.

### EXAMPLE 5

Adhesive as in Example 1, but with the following formula:

| | |
|---|---|
| 100 phr | Buna EP XT 2708 VP, |
| 64 phr | Ondina 933, |
| 193 phr | Regalite R1100 |
| 2 phr | Polypox H 205 |
| 2 phr | Irganox 1076. |

The adhesive is coated as in Example 2, but with a coatweight of only 70 g/m². The adhesive tape is wound to form log rolls without removal of the release paper.

The bond strength to steel is 9.4 N/cm. The bond strength to polyethylene is 5.3 N/cm. After ageing, the bond strength to polyethylene is still 95% of the original bond strength. The shear strength at 23° C. is 720 minutes. The adhesive tape can be adhered even at 0° C. to masonry, unsanded wood, polyethylene film or polyamide film.

### EXAMPLE 6

Adhesive as in Example 5, but with the following formula:

| | |
|---|---|
| 100 phr | Keltan DE 5005, |
| 34 phr | Ondina 933, |
| 123 phr | Foral 85 |
| 2 phr | Irganox 1076. |

The adhesive is prepared continuously in an extruder and applied at 200 g/m² from the melt to a release paper by means of nozzle coating. The carrier material possesses a thickness of 100 μm and is composed of polyethylene-coated kraft paper (20 g/m² polyethylene). The adhesive is applied to the side of the carrier material made from kraft paper, by lamination from coated release paper. The adhesive tape is wound to form log rolls, without removal of the release paper.

Bond strength to steel is 16 N/cm. The bond strength to polyethylene is 8 N/cm. The shear strength at 23° C. is 50 minutes. Detachment in the heat and humidity storage test: <1 mm. The adhesive tape can be adhered even at 0° C. to masonry, unsanded wood, polyethylene film or polyamide film.

### COMPARATIVE EXAMPLE 1

Production as in Example 1 but with Vistamaxx 3000 instead of Vistalon 7500. Bond strength to steel and to polyethylene is above 20 N/cm (adhesive splits due to cohesive fracture). The shear strength at 23° C. is <1 minute. Detachment in the heat and humidity storage test: complete.

1. An adhesive assembly tape for interior finishing, the adhesive assembly tape comprises a carrier and an adhesive coated, from a melt, to at least one side of said carrier, wherein the adhesive comprises an ethylene-propylene rubber, having a density of between 0.86 and 0.89 g/cm³ and a tackifier resin.

2. The adhesive assembly tape according to claim 1, wherein the adhesive contains no further polyolefin having a crystallite melting point of 105° C. or higher.

3. The adhesive assembly tape according to claim 1, wherein the ethylene-propylene rubber does not have a crystallite melting point of 105° C. or higher.

4. The adhesive assembly tape according to claim 1, wherein the ethylene-propylene rubber has a Mooney viscosity of at least 20.

5. The adhesive assembly tape according to claim 1, wherein the ethylene-propylene rubber has a melt index of less than 0.5 g/10 min.

6. The adhesive assembly tape according to claim 1, wherein the ethylene-propylene rubber is grafted with a crosslinkable comonomer.

7. The adhesive assembly tape according to claim 1, wherein the ethylene-propylene rubber is an EPDM.

8. The adhesive assembly tape according to claim 1, wherein the ethylene-propylene rubber contains less than 75% by weight of ethylene.

9. The adhesive assembly tape according to claim 1, wherein the adhesive comprises
a primary antioxidant, and/or
a secondary antioxidant and/or
a light stabilizer, and/or
a UV absorber.

10. The adhesive assembly tape according to claim 1, wherein the adhesive is applied at 50 to 300 g/m² to the carrier and/or the bond strength is at least 10 N/cm.

11. The adhesive assembly tape according to claim 1, wherein the adhesive is crosslinked.

12. The adhesive assembly tape according to claim 1, wherein the carrier comprises at least one ply.

13. The adhesive assembly tape according to claim 1, wherein, to improve adhesive anchorage, the carrier has treated surface or the carrier is pretreated with a primer.

14. A method for finishing an interior, the method comprising:
applying the adhesive assembly tape according to claim 1 to said interior.

15. A method for adhesive bonding of wind seals, vapour diffusion retarders and vapour barriers, the method comprising:
bonding said wind seals, said vapour diffusion retarders or vapour barriers with the adhesive assembly tape according to claim 1.

16. The adhesive assembly tape according to claim 1, wherein the ethylene-propylene rubber contains less than 60% by weight of ethylene.

17. The adhesive assembly tape according to claim 9, wherein the primary antioxidant is present in an amount of at least 2 phr.

18. The adhesive assembly tape according to claim 9, wherein the light stabilizer is a HALS.

19. The adhesive assembly tape according to claim 10, wherein the adhesive is applied to the carrier at 100 to 150 g/m².

20. The adhesive assembly tape according to claim 12, wherein the ply is a film of polyolefin, polyester and/or PVC or a paper or a nonwoven scrim or a textile or of an assembly of polyolefin, polyester, PVC, paper, nonwoven scrim and/or textile.
